(19) United States
(12) Patent Application Publication
(10) Pub. No.: US 2012/0259030 A1
(43) Pub. Date: Oct. 11, 2012

(54) PRODUCING PU RIGID FOAMS

(75) Inventors: Andreas KUNST, Ludwigshafen (DE); Marc Fricke, Osnabrueck (DE); Andreas Emge, Shanghai (CN); Markus Schütte, Osnabrueck (DE)

(73) Assignee: BASF SE, Ludwigshafen (DE)

(21) Appl. No.: 13/438,069

(22) Filed: Apr. 3, 2012

Related U.S. Application Data
(60) Provisional application No. 61/472,647, filed on Apr. 7, 2011.

(51) Int. Cl. C08G 18/50; C08G 18/08; C08J 9/12; C08G 18/48; C08J 9/06

(52) U.S. Cl. 521/164; 521/174

(57) ABSTRACT

The present invention relates to a process for producing polyurethane (PU) rigid foams by reaction of polyisocyanates with compounds having two or more isocyanate-reactive hydrogen atoms in the presence of blowing agents.

The present invention relates to a process for producing polyurethane (PU) rigid foams by reaction of polyisocyanates with compounds having two or more isocyanate-reactive hydrogen atoms in the presence of blowing agents.

Polyurethane rigid foams are long known and are predominantly used for thermal insulation, for example in refrigerating appliances, hot water storage systems, district heating pipes or building construction, for example in sandwich elements. A comprehensive overview of the production and use of isocyanate-based rigid foams is given for example in Kunststoff-Handbuch, volume 7, Polyurethanes, 1st edition 1966, edited by Dr. R. Vieweg and Dr. A. Höchtlen, and 2^{nd} edition 1983, edited by Dr. Günter Oertel, and 3^{rd} edition 1993, edited by Dr. Günter Oertel, Carl Hanser Verlag, Munich, Vienna.

Isocyanate-based rigid foams are typically produced using polyols having high functionalities and relatively short chains in order that optimum crosslinking of foams may be ensured. The preferred polyether alcohols usually have a functionality of 4 to 8 and a hydroxyl number between 300 and 600 and more particularly between 400 and 500 mg KOH/g. It is known that polyols with a very high functionality and hydroxyl numbers between 300 and 600 have a very high viscosity, and so they cannot be used in formulations to be processed on customary manufacturing equipment. It is also known that polyols of this type are very polar and thus have poor solubility for hydrocarbons. To remedy this defect, the polyol component frequently includes polyether alcohols having functionalities between 2 and 4 and a hydroxyl number ranging from 250 to 450 mg KOH/g. WO2008/058863 describes a polyurethane rigid foam produced using a polyether alcohol based on TDA (tolylenediamine). Polyols of this type are notable for a relatively low functionality and cause late curing of the polyurethane system. Hence even complicated cavities of the type occurring in refrigerating equipment in particular can be fully filled therewith. It is known that the flowability of polyol components based on high-functionality, polar polyols is not always satisfactory.

EP 1 138 709 discloses that rigid foams having good flowability are obtainable when compounds having two or more isocyanate-reactive hydrogen atoms comprise at least one polyether alcohol having a hydroxyl number of 100 to 250 mg KOH/g and obtained by addition of alkylene oxides onto H-functional starting substances having 2 to 4 active hydrogen atoms, more particularly glycols, trimethylolpropane, glycerol, pentaerythritol or TDA (tolylenediamine).

The foams obtained by the processes described still do not meet all technical requirements.

The problem addressed by the present invention is therefore that of providing a process for producing polyurethane rigid foams having optimum flow characteristics coupled with low viscosity for the polyol component. In addition, high solubility of the generally apolar blowing agents in the system and a compatibility between the polyols used should be ensured. At the same time, a high compressive strength should be achieved to allow low densities to be established in the structural component.

Surprisingly, this problem is solved when melamine polyetherols are used as a component of the rigid foam formulation.

Melamine polyetherols are obtainable for example by ring-opening polymerization of alkylene oxides with melamine/co-initiator mixtures as described in DE 3 412 082 A1 for example.

The present invention thus provides a process for producing polyurethane rigid foams, which comprises (a) reacting at least one polyisocyanate by using (b) at least one blowing agent with (c) three or more different compounds each having two or more isocyanate-reactive hydrogen atoms, wherein (i) one of the three or more different compounds each having two or more isocyanate-reactive hydrogen atoms is a polyether alcohol component obtainable by reacting a mixture of melamine and at least one further hydroxyl- and/or amino-functional compound having a functionality ranging from 2 to 8 with at least one alkylene oxide, and (ii) a further one of the three or more different compounds each having two or more isocyanate-reactive hydrogen atoms is a polyether alcohol component having a hydroxyl number of 300 to 600 mg KOH/g coupled with an average functionality of 4 to 8, and (iii) the third one of the three or more different compounds each having two or more isocyanate-reactive hydrogen atoms is a polyether alcohol and/or polyester alcohol component having a hydroxyl number of 100 to 350 mg KOH/g coupled with an average functionality of 2 to 5 and preferably 2 to 4.

Hydroxyl number is measured according to German Standard Specification DIN 53240; average functionality relates to free OH groups.

The present invention further provides polyurethane rigid foams obtainable by the process of the present invention, and also the use of a polyurethane rigid foam obtainable by the process of the present invention as thermal insulating material in refrigerating appliances, hot water storage systems, district heating pipes or building construction.

In one embodiment of the process according to the present invention, the polyether alcohol component (i) is obtained without a catalyst.

In a further embodiment of the process according to the present invention, the polyether alcohol component (i) is obtainable by reacting a mixture of melamine and a further hydroxyl- and/or amino-functional compound in a mass ratio ranging from 3:1 to 1:3 and a mixture functionality in the range from 4 to 6, with at least one alkylene oxide.

Component (i) is obtained using as coinitiator compound reacted in the process with the alkylene oxide together with the melamine in the reaction mixture, at least one further hydroxyl- and/or amino-functional compound having a functionality of 2-8 and preferably of 2-6.

The hydroxyl-functional compound under (i) may be selected from the group ethylene glycol, diethylene glycol, propylene glycol, dipropylene glycol, 1,3-propanediol, 1,4-butanediol, neopentylglycol, 1,5-pentanediol, 3-methyl-1,5-pentanediol, 1,6-hexanediol, 1,9-nonanediol, 2-methyl-1,8-octanediol, cyclohexanediol or dichlorohexanedimethanol, glycerol, trimethylolpropane, trimethylolethane, pentaerythritol, sucrose, sacarose, glucose, fructose, mannose, sorbitol, dipentaerythritol, tripentaerythritol, polyesters such as, for example, polyesters based on caprolactone or 1,4-butanediol and adipic acid, initiators based on renewable raw materials e.g., hydroxyl-containing fats such as, for example, castor oil or other hydroxyl-modified natural oils such as sunflower oil, soybean oil, rapeseed oil, palm oil, etc., and/or hydroxyl-containing fatty acid esters such as hydroxyalkyl stearate, hydroxyalkyl oleate, hydroxyalkyl linolate, hydroxyalkyl linoleoate specifically methyl esters and ethyl esters of hydroxy fatty acids, lignin and/or salts thereof such as, for example, ligninsulfonate, polysaccharides, such as starch, cellulose, guar.

The amino-functional compound under (i) may be selected from the group ammonia, butylamine, aniline, methoxyaniline, cyclohexylamines, 2-ethylhexylamine, dimethylamine, diethylamine, ethylenediamine, N-methylaniline, N-ethylaniline, 1,3-diaminopropane, 3-(N,N-dimethylamino)propylamine, 2,3-tolylenediamine, 2,4-tolylenediamine, 2,6-tolylenediamine, phenylenediamine, or mixtures thereof. Ethanolamine, isopropanolamine, aminophenol, diethanolamine, N-methylmonoethanolamine, N-methyldiethanolamine, N-methylaminophenol, triethanolamine, tris(hydroxymethyl)aminomethane, triisopropanolamine, N,N-dimethylethanolamine, monoethanolamine, diethanolamine, diethylenediamine.

The hydroxyl- or amino-functional compounds under (i) may each be used as pure substances or as mixtures.

Optionally, (i) may also utilize alkylene oxide addition products of the abovementioned initiator substances or addition products of melamine as coinitiators in the process. It is further conceivable for the reaction product of the above-described process itself to be used as a coinitiator in the reaction mixture together with the melamine.

In a further embodiment of the process according to the present invention, the polyether alcohol component (i) is obtainable by reacting a mixture of melamine and a further hydroxyl- and/or amino-functional compound selected from the group comprising glycerol, propylene glycol, ethylene glycol, dipropylene glycol, diethylene glycol, trimethylolpropane, sorbitol, urea, biuret, triethanolamine, diethanolamine, ethanolamine, triisopropanolamine, diisopropanolamine, isopropanolamine, ethylenediamine (EDA), tolylenediamine (TDA) and methylenedianiline (MDA), with at least one alkylene oxide.

In a further embodiment of the process according to the present invention, the at least one alkylene oxide under (i) is selected from the group comprising propylene oxide, ethylene oxide, 1,2-butylene oxide and styrene oxide; preference is given to using propylene oxide or propylene oxide/ethylene oxide mixtures.

In a preferred embodiment of the process according to the present invention, the polyether alcohol component (i) is obtainable by reacting a mixture of melamine and a further hydroxyl- and/or amino-functional compound selected from the group comprising glycerol, propylene glycol, ethylene glycol, dipropylene glycol, diethylene glycol, trimethylolpropane, sorbitol, triethanolamine, ethanolamine, tolylenediamine, with at least one alkylene oxide, wherein the alkylene oxide is selected from the group comprising propylene oxide and propylene oxide/ethylene oxide mixtures.

In a further embodiment of the process according to the present invention, the polyether alcohol component (i) is obtained in a temperature range between 120 and 180° C.

Instead of melamine (unsubstituted 2,4,6-triamino-1,3,5-triazine), other aminotriazines also come into consideration under (i), for example hydroxyl-, alkyl- or aryl-substituted aminotriazines, e.g., benzoguanamine, valeroguanamine, hexanoguanamine, lauroguanamine, stearoguanamine, acetoguanamine, caprinoguanamine or ammeline or mixtures thereof. However, it is preferable to use unsubstituted 2,4,6-triamino-1,3,5-triazine (also called melamine). The aminotriazine can be used as pure substance or as mixture with other aminotriazines.

In component (i), the ratio of melamine to the coinitiator (i.e., to the at least one further hydroxyl- and/or amino-functional compound) in the initiator mixture is generally in the range from 95:5 to 5:95 mass percent, preferably in the range from 30:70 to 70:30 mass percent and more preferably in the range from 40:60 to 60:40 mass percent.

The addition reaction of the alkylene oxide involved in obtaining component (i) can take place in the presence of basic alkylene oxide addition catalysts such as alkali metal hydroxides or alkali metal alkoxides and also amines. In a more advantageous and preferred embodiment, the addition reaction entirely takes place without the presence of alkylene oxide addition catalysts.

The alkylene oxide addition reaction involved in obtaining component (i) takes place at temperatures of 100° C. to 200° C., preferably of 120° to 180° C., and more preferably of 140° C. to 170° C. The reaction takes place in the pressure range between 0 and 20 bar and preferably between 0 and 10 bar.

The alkylene oxide for the reaction to obtain component (i) can be wholly or partly included in the initial charge together with the initiator mixture of melamine and at least one further hydroxyl- and/or amino-functional compound and wholly or partly added during the reaction. As a result, the process can be carried out in batch mode or in semibatch mode, the semibatch process being preferred. It is further possible to add the initiator mixture before or during the synthesis. A further possibility is to perform the entire manufacturing operation continuously, in which case the initiator mixture and the alkylene oxide and/or alkylene oxide mixture are added and some of the reaction product is continuously removed from the reaction batch.

After the reaction has ended, the reaction product, i.e., component (i), is freed of residual monomer and of further volatile constituents by applying a vacuum. Optionally, a gas stream can be passed through the end product during the evacuation. Nitrogen and/or water vapor can be used as gas for the vacuum stripping. It is also conceivable to perform a sequential vacuum stripping operation by, for example, first stripping with water vapor and then with nitrogen.

After the reaction product, i.e., component (i), has been freed of residual monomer, it can optionally be neutralized by addition of acidic substances such as phosphoric acid, sulfuric acid, hydrochloric acid, nitric acid and/or CO₂ and subsequent filtration. This is necessary particularly when the addition reaction of the alkylene oxides takes place in the presence of alkali metal hydroxide or alkali metal alkoxide catalysts. In the case of autocatalytic reaction of the initiator compounds with alkylene oxides, this process step is not needed. As mentioned, the autocatalytic reaction with alkylene oxides is preferred.

The hydroxyl number of component (i), i.e., of the product from the reaction of a melamine-coinitiator mixture with alkylene oxide, is between 1000 and 20 mg KOH/g, preferably between 100 and 800 mg KOH/g and more preferably between 300 and 600 mg KOH/g.

In one embodiment of the process according to the present invention, the polyether alcohol component (ii) is obtainable by reacting at least one compound selected from the group comprising sucrose, glycerol, ethylene glycol, diethylene glycol, propylene glycol, dipropylene glycol, 1,4-butanediol, pentaerythritol, trimethyloipropane, water, sorbitol, urea, biuret, EDA, TDA, MDA and combinations thereof, with at least one alkylene oxide.

In a further embodiment of the process according to the present invention, the alkylene oxide used for obtaining the polyether alcohol component (ii) is selected from the group comprising propylene oxide and mixtures of propylene oxide with ethylene oxide.

In one embodiment of the process according to the present invention, the component (iii) is a polyether alcohol component obtainable by reacting aliphatic and/or aromatic amines with ethylene oxide and/or propylene oxide.

An aromatic amine is used under (iii) in one embodiment. Vicinal tolylenediamine is preferably used in this case.

An aliphatic amine is used under (iii) in a further embodiment. Ethylenediamine is preferably used in this case.

In a further embodiment of the process according to the present invention, component (iii) is a polyether alcohol component obtainable by reaction of glycerol and/or trimethylolpropane (TMP) with ethylene oxide and/or propylene oxide.

In one embodiment of the process according to the present invention, component (iii) is a polyether alcohol component selected from the group comprising alkylene oxide addition products of sugar, glycerol, ethylene glycol, diethylene glycol, propylene glycol, dipropylene glycol, 1,4-butanediol, pentaerythritol, trimethylolpropane, water or sorbitol or combinations thereof, preferably glycerol, ethylene glycol, diethylene glycol, propylene glycol and dipropylene glycol.

In a further embodiment of the process according to the present invention, component (iii) is a polyester alcohol component (iii) selected from the group comprising condensation products of adipic acid, terephthalic acid, isophthalic acid, succinic acid, with difunctional alcohols selected from the group comprising ethylene glycol and 1,4-butanediol.

The proportion of component (i), based on (i)+(ii)+(iii), is preferably between 10% and 40% by weight.

The proportion of component (ii), based on (i)+(ii)+(iii), is preferably between 30% and 60% by weight.

In a preferred embodiment of the process according to the present invention, the polyether alcohol component (i) has a hydroxyl number in the range between 300-600 mg KOH/g and is obtainable by reacting a mixture of melamine and a further hydroxyl- and/or amino-functional compound, in a mass ratio ranging from 3:2 to 2:3 and a mixture functionality ranging from 4 to 6, with propylene oxide and/or propylene oxide/ethylene oxide mixtures, and the polyether alcohol component (ii) is obtainable by addition of propylene oxide and/or propylene oxide/ethylene oxide mixtures onto tolylenediamine, and the further compound (iii) is a polyether alcohol component having a functionality of 2 to 3 and a hydroxyl number in the range between 100 and 300 mg KOH/g and is obtainable by addition of propylene oxide and/or propylene oxide/ethylene oxide mixtures onto glycerol, ethylene glycol, diethylene glycol, propylene glycol or dipropylene glycol or mixtures thereof.

In one embodiment of the process according to the present invention, the at least one polyisocyanate (a) is selected from the group comprising aromatic, aliphatic and cycloaliphatic polyisocyanates.

Here the term “polyisocyanate” for the purposes of this invention comprises compounds having two or more isocyanate groups, for example diphenylmethane diisocyanate (MDI), tolylene diisocyanate (TDI), tri-, tetra-, penta-, hexa-, hepta- and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate, 4,4′-, 2,4′- and/or 2,2′-dicyclohexylmethane diisocyanate; preference is given to the use of MDI and/or TDI.

In one embodiment of the process according to the present invention, the at least one blowing agent (b) is selected from the group comprising physical blowing agents and chemical blowing agents.

It is preferable to use exactly one physical blowing agent and exactly one chemical blowing agent.

In combination with or in place of chemical blowing agents, physical blowing agents can also be used. Physical blowing agents are compounds which are inert with regard to the use components, usually liquid at room temperature and vaporize under the conditions of the urethane reaction. The boiling point of these compounds is preferably below 50° C. Useful physical blowing agents also include compounds that are gaseous at room temperature and are introduced into and/or dissolved in the use components under pressure, for example carbon dioxide, low-boiling alkanes and fluoroalkanes.

Physical blowing agents are usually selected from the group comprising alkanes and/or cycloalkanes having at least 4 carbon atoms, dialkyl ethers, esters, ketones, acetals, fluoroalkanes having 1 to 8 carbon atoms, and tetraalkylsilanes having 1 to 3 carbon atoms in the alkyl chain, more particularly tetramethylsilane.

In one preferred embodiment of the invention, the blowing agents (c) are hydrocarbons. The blowing agents are more preferably selected from the group comprising alkanes and/or cycloalkanes having at least 4 carbon atoms. Pentanes are used in particular, preferably isopentane and cyclopentane. When the rigid foams are used as insulation in refrigerating appliances, cyclopentane is preferred. The hydrocarbons can be used in admixture with water.

Examples of blowing agents (c) useful according to the present invention are propane, n-butane, isobutane, cyclobutane, n-pentane, isopentane, cyclopentane, cyclohexane, dimethyl ether, methyl ethyl ether, methyl butyl ether, methyl formate, acetone, and also fluoroalkanes which can be degraded in the troposphere and therefore are harmless to the ozone layer, such as trifluoromethane, difluoromethane, 1,1,1,3,3-pentafluorobutane, 1,1,1,3,3-pentafluoro-propane, 1,1,1,2-tetrafluoroethane, difluoroethane and 1,1,1,2,3,3,3-heptafluoropropane, and also perfluoroalkanes, such as C₃F₈, C₄F₁₀, C₅F₁₂, C₆F₁₄, and C₇F₁₆. The physical blowing agents mentioned can be used alone or in any desired combination with each or one another.

Useful blowing agents further include hydrofluorolefins, such as 1,3,3,3-tetrafluoropropene, or hydrochlorofluorolefins, such as 1-chloro-3,3,3-trifluoropropene. Blowing agents of this type are described in WO 2009/048826 for example.

Water is used as chemical blowing agent in a preferred embodiment where it reacts with isocyanate groups to eliminate carbon dioxide. Formic acid can also be used for example as physical blowing agent.

Polyurethane rigid foams are obtainable according to the present invention in the presence or absence of catalysts, flame retardants and also customary auxiliary and/or addition agents.

As catalysts there are more particularly used compounds which substantially speed the reaction of the isocyanate groups with the isocyanate-reactive groups.

Such catalysts are strong basic amines, for example secondary aliphatic amines, imidazoles, amidines, and also alkanolamines or organometallic compounds, more particularly organotin compounds.

When the polyurethane rigid foam is to incorporate isocyanurate groups as well, specific catalysts are needed. As isocyanurate catalysts there are typically used metal carboxylates, more particularly potassium acetate and its solutions.

The catalysts can be used either alone or in any desired mixtures, as required.

As auxiliaries and/or additive agents there are used the substances known per se for this purpose, examples being surface-active substances, foam stabilizers, cell regulators, fillers, pigments, dyes, flame retardants, hydrolysis control agents, antistats, fungistatically and bacteriostatically active agents.

Further particulars concerning starting compounds used are given for example in Kunststoffhandbuch, volume 7, “Polyurethanes,”, edited by Günter Oertel, Carl-Hanser-Verlag, Munich, 3^{rd} edition, 1993.

### EXAMPLES

The paragraphs which follow give some examples to illustrate some aspects of the present invention. These examples shall in no way be deemed to restrict the scope of the invention.

### Synthesis Example 1

1.44 kg of melamine are initially charged to a 20 L steel autoclave together with 1.44 kg of glycerol and the reaction mixture is heated to 160° C. under agitation. After the reaction temperature has been reached, 11.51 kg of propylene oxide are added over 6 hours. This is followed by a five-hour secondary reaction until the pressure assumes a constant value. Then, the crude product is freed of residual monomer and other volatile components at 15 mbar and 160° C. for 60 minutes to obtain 14 kg of a slightly yellowish viscous liquid.

| | | |
|---|---|---|
| Hydroxyl value: | 467 mg KOH/g | (DIN 53240) |
| Viscosity (at 25° C.): | 2161 mPas | (DIN 51550) |

### Synthesis Example 2

1.2 kg of melamine are initially charged to a 20 L steel autoclave together with 1.8 kg of trimethylolpropane and the reaction mixture is heated to 160° C. under agitation. After the reaction temperature has been reached, 9.69 kg of propylene oxide are added over 7 hours. This is followed by a six-hour secondary reaction until the pressure assumes a constant value. Then, the crude product is freed of residual monomer and other volatile components at 15 mbar and 160° C. for 60 minutes to obtain 12 kg of a slightly yellowish viscous liquid.

| | | |
|---|---|---|
| Hydroxyl value: | 490 mg KOH/g | (DIN 53240) |
| Viscosity (at 25° C.): | 4996 mPas | (DIN 51550) |

### Synthesis Example 3

1.44 kg of melamine are initially charged to a 20 L steel autoclave together with 1.44 kg of sorbitol and the reaction mixture is heated to 160° C. under agitation. After the reaction temperature has been reached, 11.5 kg of propylene oxide are added over 10 hours. This is followed by a seven-hour secondary reaction until the pressure assumes a constant value. Then, the crude product is freed of residual monomer and other volatile components at 15 mbar and 160° C. for 60 minutes to obtain 14 kg of a slightly yellowish viscous liquid.

| | | |
|---|---|---|
| Hydroxyl value: | 466 mg KOH/g | (DIN 53240) |
| Viscosity (at 25° C.): | 4013 mPas | (DIN 51550) |

### Use Examples:

The products obtained according to synthesis examples 1, 2 and 3 were used in polyurethane rigid foam formulations and compared with a reference system.

### Raw Materials Used:

Polyol A: polyether alcohol from sucrose, glycerol and propylene oxide, functionality 5.1, hydroxyl number 450, viscosity 20 000 mPa·s at 25° C.
Polyol B: polyether alcohol from vicinal TDA, ethylene oxide and propylene oxide, ethylene oxide content: 15%, functionality 3.8, hydroxyl number 390, viscosity 13 000 mPa·s at 25° C.
Polyol C: polyether alcohol from vicinal TDA, ethylene oxide and propylene oxide, ethylene oxide content: 15%, functionality 3.9, hydroxyl number 160, viscosity 650 mPa·s at 25° C.
Stabilizer: Tegostab® B 8462 (silicone stabilizer from Evonik)
Catalyst 1: dimethylcyclohexylamine (BASF)
Catalyst 2: pentamethyldiethylenetriamine (BASF)
Catalyst 3: N,N′,N″-tris(dimethylaminopropyl)-s-hexahydrotriazine (BASF)
Isocyanate: polymer MDI (Lupranat® M20, BASF)

### Machine Foaming:

The stated raw materials were used to obtain a polyol component. Using a high pressure Puromat® PU 30/80 IQ (BASF Polyurethanes GmbH) with an application rate of 250 g/sec., the polyol component was mixed with the requisite amount of the stated isocyanate, so that an isocyanate index of 116.7 was obtained (unless otherwise stated). The reaction mixture was injected into heated molds of dimensions 2000 mm×200 mm×50 mm and 400 mm×700 mm×90 mm and allowed to foam up therein. Overpacking was 15%.

| | 1 | | | |
|---|---|---|---|---|
| | (reference) | 2 | 3 | 4 |
| | (wt %) | (wt %) | (wt %) | (wt %) |
| polyol A | 47.88 | 47.88 | 47.88 | 47.88 |
| polyol B | 30 | 0 | 0 | 0 |
| polyol C | 16 | 16 | 16 | 16 |
| polyol of example 1 | 0 | 30 | 0 | 0 |
| polyol of example 2 | 0 | 0 | 30 | 0 |
| polyol of example 3 | 0 | 0 | 0 | 30 |
| stabilizer | 1.9 | 1.9 | 1.9 | 1.9 |
| water | 2.3 | 2.3 | 2.3 | 2.3 |
| catalyst 1 | 1.222 | 1.328 | 1.328 | 1.328 |
| catalyst 2 | 0.599 | 0.651 | 0.651 | 0.651 |
| catalyst 3 | 0.479 | 0.521 | 0.521 | 0.521 |
| cyclopentane 70% | 13 | 13 | 13 | 13 |
| setting time [s] | 35 | 33 | 35 | 35 |
| free rise density [g/L] | 23.0 | 23.2 | 22.7 | 23.1 |
| viscosity of polyol | 8400 | 6000 | 5300 | 6100 |
| component [mPas] | | | | |
| minimum fill density | 30.8 | 31.1 | 30.4 | 31.1 |
| [g/L] | | | | |
| flow index (min. fill | 1.34 | 1.34 | 1.34 | 1.35 |
| density/free rise density) | | | | |
| thermal conductivity | 19.7 | 19.9 | 19.7 | 19.7 |
| [mW/m*K] | | | | |
| compressive strength | 15.6 | 16.8 | 17.4 | 17.0 |
| (density 31) 15% OP, | | | | |
| [N/mm²] | | | | |

Example 1 is a comparative example. The systems in examples 2, 3 and 4 (all in accordance with the present invention), featuring melamine alcohols based on melamine, a coinitiator and propylene oxide, have distinctly improved mechanical stability, which manifests in increased compressive strength. Furthermore, the viscosities of the polyol mixtures are distinctly lower than in the comparative example.

We claim:

1. A process for producing polyurethane rigid foams, which comprises (a) reacting at least one polyisocyanate by using (b) at least one blowing agent with (c) three or more different compounds each having two or more isocyanate-reactive hydrogen atoms, wherein (i) one of the three or more different compounds each having two or more isocyanate-reactive hydrogen atoms is a polyether alcohol component obtainable by reacting a mixture of melamine and at least one further hydroxyl- and/or amino-functional compound having a functionality ranging from 2 to 8 with at least one alkylene oxide, and (ii) a further one of the three or more different compounds each having two or more isocyanate-reactive hydrogen atoms is a polyether alcohol component having a hydroxyl number of 300 to 600 mg KOH/g coupled with an average functionality of 4 to 8, and (iii) the third one of the three or more different compounds each having two or more isocyanate-reactive hydrogen atoms is a polyether alcohol and/or polyester alcohol component having a hydroxyl number of 100 to 350 mg KOH/g coupled with an average functionality of 2 to 5.

2. The process for producing polyurethane rigid foams according to claim 1 wherein the polyether alcohol component (i) is obtained without a catalyst.

3. The process for producing polyurethane rigid foams according to claim 1 or 2 wherein the polyether alcohol component (i) is obtainable by reacting a mixture of melamine and a further hydroxyl- and/or amino-functional compound in a mass ratio ranging from 3:1 to 1:3 and a mixture functionality in the range from 4 to 6, with at least one alkylene oxide.

4. The process for producing polyurethane rigid foams according to any one of claims 1 to 3 wherein the polyether alcohol component (i) is obtainable by reacting a mixture of melamine and a further hydroxyl- and/or amino-functional compound selected from the group comprising glycerol, propylene glycol, ethylene glycol, dipropylene glycol, diethylene glycol, trimethylolpropane, sorbitol, urea, biuret, triethanolamine, diethanolamine, ethanolamine, triisopropanolamine, diisopropanolamine, isopropanolamine, ethylenediamine (EDA), tolylenediamine (TDA) and methylenedianiline (MDA), with at least one alkylene oxide.

5. The process for producing polyurethane rigid foams according to any one of claims 1 to 4 wherein the at least one alkylene oxide under (i) is selected from the group comprising propylene oxide, ethylene oxide, 1,2-butylene oxide and styrene oxide.

6. The process for producing polyurethane rigid foams according to any one of claims 1 to 5 wherein the alkylene oxide under (i) is selected from the group comprising propylene oxide and propylene oxide/ethylene oxide mixtures.

7. The process for producing polyurethane rigid foams according to any one of claims 1 to 6 wherein the polyether alcohol component (i) is obtained in a temperature range between 120 and 180° C.

8. The process according to any one of claims 1 to 7 wherein the polyether alcohol component (ii) is obtainable by reacting at least one compound selected from the group comprising sucrose, glycerol, ethylene glycol, diethylene glycol, propylene glycol, dipropylene glycol, 1,4-butanediol, pentaerythritol, trimethylolpropane, water, sorbitol, urea, biuret, EDA, TDA, MDA and combinations thereof, with at least one alkylene oxide.

9. The process according to any one of claims 1 to 8 wherein the alkylene oxide used for obtaining the polyether alcohol component (ii) is selected from the group comprising propylene oxide and mixtures of propylene oxide with ethylene oxide.

10. The process for producing polyurethane rigid foams according to any one of claims 1 to 9 wherein the component (iii) is a polyether alcohol component obtainable by reacting aliphatic and/or aromatic amines with ethylene oxide and/or propylene oxide.

11. The process for producing polyurethane rigid foams according to claim 10 wherein an aromatic amine is used under (iii).

12. The process for producing polyurethane rigid foams according to claim 11 wherein the aromatic amine under (iii) is vicinal tolylenediamine.

13. The process for producing polyurethane rigid foams according to claim 10 wherein an aliphatic amine is used under (iii).

14. The process for producing polyurethane rigid foams according to claim 13 wherein the aliphatic amine under (iii) is ethylenediamine.

15. The process for producing polyurethane rigid foams according to any one of claims 1 to 9 wherein the component (iii) is a polyether alcohol component obtainable by reaction of glycerol and/or trimethylolpropane with ethylene oxide and/or propylene oxide.

16. The process according to any one of claims 1 to 15 wherein the proportion of component (i), based on (i)+(ii)+(iii), is between 10% and 40% by weight.

17. The process according to any one of claims 1 to 16 wherein the proportion of component (ii), based on (i)+(ii)+(iii), is between 30% and 60% by weight.

18. The process for producing polyurethane rigid foams according to any one of claims 1 to 17 wherein the at least one polyisocyanate (a) is selected from the group comprising aromatic, aliphatic and cycloaliphatic polyisocyanates.

19. The process for producing polyurethane rigid foams according to any one of claims 1 to 18 wherein the at least one blowing agent (b) is selected from the group comprising physical blowing agents and chemical blowing agents.

20. A polyurethane rigid foam obtainable by the process of any one of claims 1 to 19.

21. The use of a polyurethane rigid foam obtainable by the process of any one of claims 1 to 19 as thermal insulating material in refrigerating appliances, hot water storage systems, district heating pipes or building construction.
